(19) United States
(12) Patent Application Publication
(10) Pub. No.: US 2013/0136336 A1
(43) Pub. Date: May 30, 2013

(54) IMAGE PROCESSING APPARATUS AND CONTROLLING METHOD FOR IMAGE PROCESSING APPARATUS

(71) Applicant: Tse Kai HENG, Fuchu-shi (JP)

(72) Inventor: Tse Kai HENG, Fuchu-shi (JP)

(73) Assignee: KABUSHIKI KAISHA TOSHIBA, Tokyo (JP)

(21) Appl. No.: 13/598,532

(22) Filed: Aug. 29, 2012

(30) Foreign Application Priority Data
Nov. 24, 2011 (JP) 2011-256364

(51) Int. Cl. G06K 9/46; G06K 9/00

(52) U.S. Cl. 382/154

(57) ABSTRACT

According to one embodiment, an image processing apparatus includes, a composition estimation module configured to estimate a composition from a two-dimensional image, an inmost color determination module configured to determine an inmost color based on the estimated composition and the two-dimensional image, a first depth generator configured to generate a first depth for each of multiple regions in the two-dimensional image based on the inmost color, and an image processor configured to convert the two-dimensional image into a three-dimensional image using the first depth.

This application is based upon and claims the benefit of priority from prior Japanese Patent Application No. 2011-256364, filed Nov. 24, 2011; the entire contents of which are incorporated herein by reference.

### FIELD

Embodiments described herein relate generally to image processing apparatus and controlling method for image processing apparatus.

### BACKGROUND

Conventionally, electronic apparatuses such as an image processing apparatus capable of playing video contents such as movies, television programs, and games have been widely used in general.

In recent years, an image processing apparatus capable of allowing a user to perceive a two-dimensional image as a stereoscopic image has been put into practical use. The image processing apparatus generates a left eye image that can be perceived by a left eye and a right eye image that can be perceived by a right eye, and causes a display device to display the left eye image and the right eye image. The image processing apparatus allows the left eye of the user to perceive the left eye image and allows the right eye of the user to perceive the right eye image, so that the user can recognize the image as a stereoscopic object.

In processing for converting 2D video into 3D video (2D-3D conversion), the depth of each of multiple regions on the video is calculated based on the video. An example of 2D-3D conversion includes a color 3D processing for calculating the depth of each of multiple regions on the video based on the colors of the video. However, when a 3D video is generated based on the depth generated by a conventional color 3D processing, the user may feel strange. For example, this may occur when there is a great contrast in color between the face and the black hair of a person. In this case, a contrast in depth between the face and the black hair may be increased.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary view showing an image processing apparatus according to an embodiment.

FIG. 2 is an exemplary view showing the image processing apparatus according to the embodiment.

FIG. 3 is an exemplary view showing the image processing apparatus according to the embodiment.

FIG. 4 is an exemplary view showing the image processing apparatus according to the embodiment.

FIG. 5 is an exemplary view showing the image processing apparatus according to the embodiment.

FIG. 6 is an exemplary view showing the image processing apparatus according to the embodiment.

FIG. 7 is an exemplary view showing the image processing apparatus according to the embodiment.

### DETAILED DESCRIPTION

Various embodiments will be described hereinafter with reference to the accompanying drawings. In general, according to one embodiment, an image processing apparatus comprises, a composition estimation module configured to estimate a composition from a two-dimensional image, an inmost color determination module configured to determine an inmost color based on the estimated composition and the two-dimensional image, a first depth generator configured to generate a first depth for each of multiple regions in the two-dimensional image based on the inmost color, and an image processor configured to convert the two-dimensional image into a three-dimensional image using the first depth.

Hereinafter, an image processing apparatus and a controlling method for the image processing apparatus according to an embodiment will be explained in detail with reference to drawings.

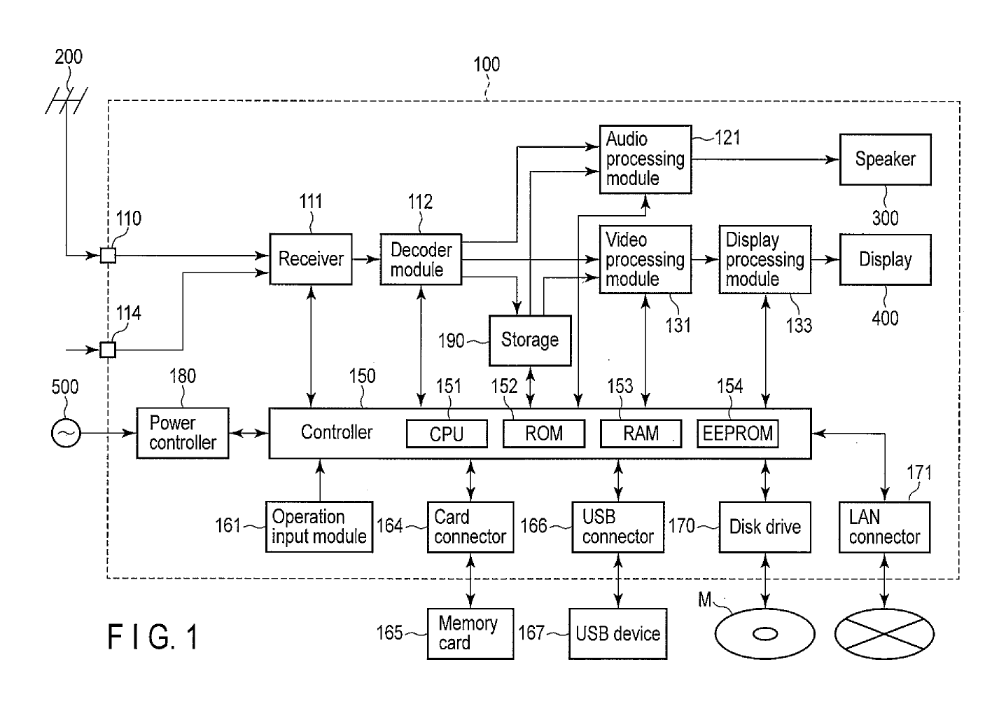

FIG. 1 illustrates an example of a broadcast receiving apparatus 100 serving as an image processing apparatus according to an embodiment.

The broadcast receiving apparatus 100 includes a main body provided with a display (display 400) for displaying video and a foot portion for supporting the main body in such a manner that it can stand on its own.

In addition, the broadcast receiving apparatus 100 includes a broadcast input terminal 110, a receiver 111, a decoder module 112, a communication interface 114, an audio processing module 121, a video processing module 131, a display processing module 133, a controller 150, an operation input module 161, a card connector 164, a USB connector 166, a disk drive 170, a LAN connector 171, a power controller 180, and a storage 190. In addition, the broadcast receiving apparatus 100 includes a speaker 300 and a display 400.

The broadcast input terminal 110 is, for example, an input terminal to which a digital broadcast signal received by an antenna 200 is input. The antenna 200 receives, for example, a digital terrestrial broadcast signal, a BS (broadcasting satellite) digital broadcast signal, and/or, a 110-degrees CS (communication satellite) digital broadcast signal. In other words, the broadcast input terminal 110 receives contents such as programs provided by broadcast signals.

The broadcast input terminal 110 provides the received digital broadcast signal to the receiver 111. The receiver 111 is a receiver for digital broadcast signals. The receiver 111 tunes in to (selects) a digital broadcast signal provided from the antenna 200. The receiver 111 transmits the digital broadcast signal, to which the receiver 111 tunes in to, to the decoder module 112. When the signal provided from the broadcast input terminal 110 or the communication interface 114 is an analog signal, the receiver 111 converts the signal into a digital signal.

The decoder module 112 demodulates the received digital broadcast signal. Further, the decoder module 112 performs signal processing on the demodulated digital broadcast signal (content). As a result, the decoder module 112 decodes a video signal, an audio signal, and other data signals from the digital broadcast signal. For example, the decoder module 112 decodes a transport stream (TS), in which the video signal, the audio signal, the other data signals, and the like, are multiplexed, from the digital broadcast signal.

The decoder module 112 provides the audio signal to the audio processing module 121. In addition, the decoder module 112 provides the video signal to the video processing module 131. Further, the decoder module 112 provides a data signal to the controller 150. In other words, the antenna 200, the receiver 111, and the decoder module 112 function as a receiver configured to receive a content.

The communication interface 114 includes one of or a plurality of interfaces capable of receiving a content, such as an HDMI (High Definition Multimedia Interface) (registered trademark) terminal, an audio input terminal, an S-video terminal, a component video terminal, a D video terminal, a D-Sub terminal, and a DVI-I terminal. The communication interface 114 receives, from another apparatus, a content in which a digital video signal, a digital audio signal, and the like are multiplexed. The communication interface 114 provides the digital signal (content), received from another apparatus, to the receiver 111. The communication interface 114 provides a content, received from another apparatus, to the decoder module 112. In other words, the communication interface 114 functions as a receiver configured to receive a content.

The decoder module 112 performs signal processing on a content provided from the communication interface 114 via the receiver 111. For example, the decoder module 112 separates the digital signal into a digital video signal, a digital audio signal, and a data signal. The decoder module 112 provides the digital audio signal to the audio processing module 121. Further, the decoder module 112 provides the digital video signal to the video processing module 131. Further, the decoder module 112 provides other information about a content to the controller 150.

Furthermore, the decoder module 112 provides the content to the storage 190 explained later based on control of the controller 150. The storage 190 stores the provided content. Therefore, the broadcast receiving apparatus 100 can record the content.

The audio processing module 121 converts the digital audio signal received from the decoder module 112 into a signal (audio signal) in a format that can be reproduced by the speaker 300. The audio processing module 121 provides the audio signal to the speaker 300. The speaker 300 plays sound based on the provided audio signal.

The video processing module 131 converts the digital video signal received from the decoder module 112 into a video signal in a format that can be reproduced by the display 400. In other words, the video processing module 131 decodes (reproduces) the video signal received from the decoder module 112 and makes it into a video signal in a format that can be reproduced by the display 400. Further, the video processing module 131 superimposes an OSU signal, provided from an OSD processing module not shown, onto the video signal. The video processing module 131 outputs the video signal to the display processing module 133.

The OSD processing module generates an OSD signal for superimposing and displaying a GUI (graphic user interface) screen, subtitles, a time, other information, or the like onto a screen, based on the data signal provided by the decoder module 112 and/or the control signal provided by the controller 150. The OSD processing module may be provided separately as a module in the broadcast receiving apparatus 100, or may be provided as a function of the controller 150.

For example, the display processing module 133 performs color, brightness, sharpness, contrast, or other image quality adjusting processing on the received video signal based on the control of the controller 150. The display processing module 133 provides the video signal, of which image quality has been adjusted, to the display 400. The display 400 displays the video based on the video signal provided.

The display 400 includes a liquid crystal display device including, for example, a liquid crystal display panel having multiple pixels arranged in a matrix form and a backlight for illuminating this liquid crystal panel. The display 400 displays a video based on the video signal provided from the broadcast receiving apparatus 100.

Instead of the display 400, the broadcast receiving apparatus 100 may be configured to have a video output terminal. Instead of the speaker 300, the broadcast receiving apparatus 100 may be configured to have an audio output terminal. In this case, the broadcast receiving apparatus 100 outputs the video signal to a display device connected to the video output terminal, and outputs an audio signal to a speaker connected to the audio output terminal. Therefore, the broadcast receiving apparatus 100 can cause the display device to display the video and can cause the speaker to output the audio.

The controller 150 functions as a controller configured to control operation of each module of the broadcast receiving apparatus 100. The controller 150 includes a CPU 151, a ROM 152, a RAM 153, an EEPROM 154, and the like. The controller 150 performs various kinds of processing based on an operation signal provided from the operation input module 161.

The CPU 151 has operation devices and the like executing various kinds of operation processing. The CPU 151 achieves various kinds of functions by executing programs stored in the ROM 152, the EEPROM 154, or the like.

The ROM 152 stores programs for achieving various kinds of functions, programs for controlling the broadcast receiving apparatus 100, and the like. The CPU 151 activates programs stored in the ROM 152 based on an operation signal provided by the operation input module 161. Accordingly, the controller 150 controls operation of each module.

The RAM 153 functions as a work memory of the CPU 151. In other words, the RAM 153 stores results of operation of the CPU 151, data read by the CPU 151, and the like.

The EEPROM 154 is a nonvolatile memory storing various kinds of setting information, programs, and the like.

The operation input module 161 includes another input device capable of generating an operation signal, according to, for example, an operation key, a keyboard, a mouse, an audio input device, a touch pad, or an input (operation). For example, the operation input module 161 may be configured to have a sensor and the like receiving an operation signal transmitted from a remote controller. The operation input module 162 may be configured to have the input device and the sensor explained above. In other words, the operation input module 161 functions as an operation signal receiver configured to receive the operation signal.

The operation input module 161 provides the received operation signal to the controller 150. The controller 150 causes the broadcast receiving apparatus 100 to perform various kinds of processing based on the operation signal provided from the operation input module 161.

It should be noted that the touch pad includes a device generating position information based on an electrostatic sensor, a thermo sensor, or other methods. When the broadcast receiving apparatus 100 includes the display 400, the operation input module 161 may be configured to include a touch panel and the like integrally formed with the display 400.

The remote controller generates an operation signal based on user's input. The remote controller transmits the generated operation signal to a sensor of the operation input module 161 via infrared communication. It should be noted that the sensor and the remote controller may be configured to transmit and receive the operation signal via other wireless communication such as radio wave.

For example, the card connector 164 is an interface for communicating with a memory card 165 storing a motion picture content. The card connector 164 reads content data of motion pictures from the connected memory card 165, and provides the content data to the controller 150.

The USB connector 166 is an interface for communicating with a USB device 167. The USB connector 166 provides the signal, provided from the connected USB device 167, to the controller 150.

For example, when the USB device 167 is an operation input device such as a keyboard, the USB connector 166 receives the operation signal from the USB device 167. The USB connector 166 provides the received operation signal to the controller 150. In this case, the controller 150 executes various kinds of processing based on the operation signal provided from the USB connector 166.

For example, when the USB device 167 is a storage device storing content data of motion pictures, the USB connector 166 can obtain the content from the USB device 167. The USB connector 166 provides the obtained content to the controller 150.

The disk drive 170 has a drive capable of loading, for example, a compact disc (CD), a digital versatile disk (DVD), a Blu-ray Disc (registered trademark), or other optical disks M capable of recording content data of motion pictures. The disk drive 170 reads the content from the loaded optical disk M, and provides the read content to the controller 150.

The LAN connector 171 is an interface for connecting the broadcast receiving apparatus 100 to a network. The controller 150 can download and upload various kinds of data via the network when the LAN connector 171 is connected to a public circuit by way of a LAN cable, a wireless LAN, or the like.

The power controller 180 controls supply of electric power to each module of the broadcast receiving apparatus 100. The power controller 180 receives electric power from a commercial power supply 500 via, for example, an AC adapter. The commercial power supply 500 provides electric power of an alternate current to the power controller 180. The power controller 180 converts the received electric power of the alternate current into a direct current and provides the direct current to each module.

In addition, the broadcast receiving apparatus 100 may further include other interfaces. An example of interface includes Serial-ATA. The broadcast receiving apparatus 100 can obtain a content recorded in the device connected via the interface and reproduce the content. The broadcast receiving apparatus 100 can output the reproduced audio signal and video signal to the device connected via the interface.

When the broadcast receiving apparatus 100 is connected to a network via the interface, the broadcast receiving apparatus 100 can obtain content data of motion pictures on the network, and reproduce the content data.

The storage 190 is a storage device storing the content. The storage 190 includes a large-capacity storage device such as a hard disk (HDD), a solid state drive (SSD), or a semiconductor memory. The storage 190 may be constituted by a storage device connected to the USB connector 166, the LAN connector 171, the communication interface 114, or other interfaces.

As described above, when a content is recorded, the controller 150 inputs data of a content demodulated by the decoder module 112 to the storage 190. Further, the controller 150 gives the storage 190 an address at which the content is stored in the storage 190. The storage 190 stores the content, provided from the decoder module 112, at an address given by the controller 150.

It should be noted that the storage 190 may be configured to store a TS which is decoded from a digital broadcast signal, or may be configured to store a compressed content obtained by compressing the TS according to AVI, MPEG, or other compression methods.

The controller 150 can read and reproduce the content stored in the storage 190. For example, the controller 150 gives an instruction of an address of the storage 190 to the storage 190. The storage 190 reads the content from the address given by the controller 150. The storage 190 provides the read content to the audio processing module 121, the video processing module 131, the controller 150, and the like. Therefore, the broadcast receiving apparatus 100 can reproduce the recorded content.

It should be noted that the broadcast receiving apparatus 100 includes multiple receivers 111 and multiple decoder modules 112. Accordingly, the broadcast receiving apparatus 100 can receive multiple contents at a time, and can decode the multiple received contents at a time. Therefore, the broadcast receiving apparatus 100 can obtain multiple pieces of reproducible content data at a time. In other words, the broadcast receiving apparatus 100 can record multiple contents at a time.

The video processing module 131 can generate a left eye image that can be perceived by a left eye and a right eye image that can be perceived by a right eye, and output the left eye image and the right eye image as a 3D video signal. The video processing module 131 performs a 2D-3D conversion for converting a 2D video signal into a 3D video signal.

The video processing module 131 calculates the depth of each of multiple regions on the video based on the video. For example, the video processing module 131 calculates the depth with one pixel being treated as one region. Further, the video processing module 131 generates a left eye image and a right eye image from a 2D video signal based on the calculated depth, and outputs the left eye image and the right eye image as a 3D video signal.

It should be noted that the depth represents the degree of deepness of the video that is to be perceived by the user. In other words, when the depth is high, it is possible to allow the user to view an object as if the object existed at a side closer to the user. When the depth is low, it is possible to allow the user to view an object as if the object existed at a side farther from the user.

It should be noted that the video processing module 131 displays a certain pixel at different positions in a left eye image and a right eye image based on the calculated depth, so that the user can have three-dimensional feeling. In other words, the video processing module 131 controls based on the depth, difference of display positions (parallax) between the left eye image and the right eye image of the certain pixel. Therefore, the video processing module 131 can control the depth that is perceived by the user.

Examples of 3D video signals include types such as side-by-side method, line-by-line method, Frame-Sequential method, Above-Below method, Checkerboard method, LR independent method, and circular polarization method. The video processing module 131 generates a 3D video signal according to any one of the methods.

The above display 400 is a display capable of displaying a 3D video signal. For example, the display 400 includes a display module, a mask, and a backlight.

The display module includes many pixels arranged in the vertical direction and the horizontal direction. The mask includes many window portions. The mask plate is provided away from the display module by a predetermined distance. A window portion is provided at a position corresponding to a pixel. The mask has an optical aperture for passing light. The mask has a function of controlling a beam of light emitted from the pixel.

For example, the mask is constituted by a transparent substrate in which a light shielding body pattern is formed with many apertures corresponding to many window portions. For example, the mask is constituted by a light shielding plate formed with many through-holes corresponding to many window portions.

Alternatively, the mask may be constituted by a fly-eye lens and the like formed by arranging many microscopic lenses in a two-dimensional manner. Further, the mask may be constituted by a lenticular lens and the like formed such that multiple optical apertures extending straightly in the vertical direction are arranged with a regular interval in the horizontal direction. It should be noted that the arrangement, the size, and the shape of the window portions may be changed in any way according to the arrangement of pixels of the display module.

The backlight is a light source emitting light. For example, the backlight has a light source such as a cold-cathode tube or an LED device. The light emitted by the backlight passes through each of the pixels of the display module, and passes through the mask. Each pixel of the display module polarizes the light passing through. Therefore, each pixel can display various kinds of colors.

In addition, the mask passes light emitted from a pixel existing on a line from a window portion. As a result, the display 400 can emit light in various colors in a predetermined direction.

According to the above configuration, when a 3D video signal is displayed, the display 400 can display the 3D video signal in such a manner that the left eye image of the 3D video signal can be viewed by the left eye of the user. On the other hand, the display 400 can display the right eye image of the 3D video signal in such a manner that the right eye image of the 3D video signal can be viewed by the right eye of the user.

As described above, the example of the stereoscopic viewing according to the integral method has been explained. However, the display 400 is not limited to the above configuration. The display 400 may be configured to allow the user to view the 3D video by means of other naked-eye methods, a shutter glasses method, or a polarized glasses method.

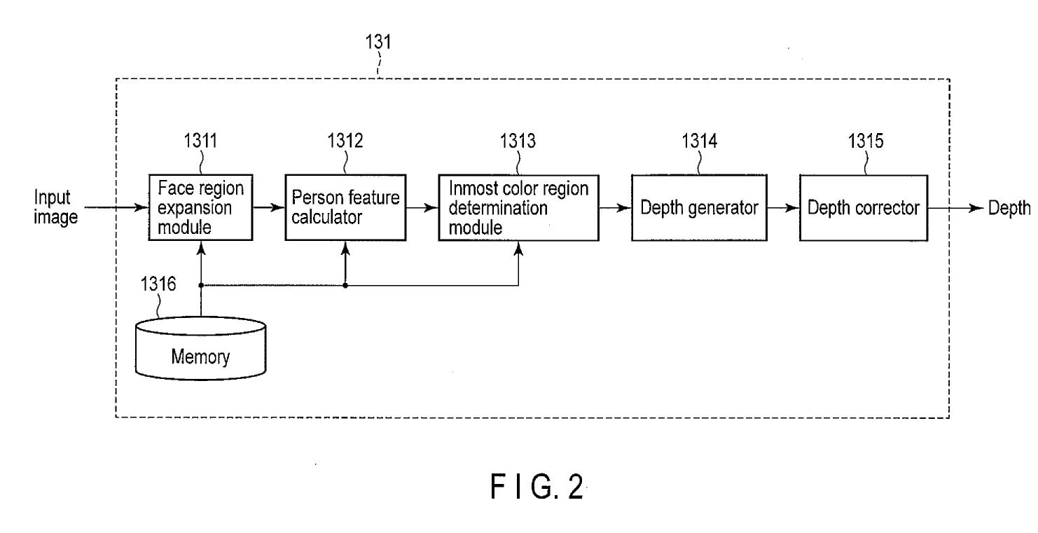

FIG. 2 illustrates an example of functions provided in the video processing module 131.

For example, the video processing module 131 executes two or more of color 3D processing, face 3D processing, baseline 3D processing, and motion 3D processing. The video processing module 131 integrates multiple depths calculated by multiple processings, and performs 2D-3D conversion based on the integrated depth.

The color 3D processing is processing for calculating the depth of each of the multiple regions on the video based on colors of 2D video. The face 3D processing is processing for detecting a facial image from the 2D video, and calculating the depth of the detected facial image. The baseline 3D processing is processing for identifying a composition from the 2D video and calculating the depth of each of the multiple regions on the video based on the identified composition. The motion 3D processing is processing for calculating the depth of each of the multiple regions on the video based on motion of an object on the 2D video.

As shown in FIG. 2, the video processing module 131 includes a face region expansion module 1311, a person feature calculator 1312, an inmost color region determination module 1313, a depth generator 1314, a depth corrector 1315, and a memory 1316. In this example, a configuration will be explained in which an ultimate depth is calculated using the color 3D processing, the face 3D processing, and the baseline 3D processing. However, the video processing module 131 may be configured to further take the processing result of the motion 3D processing into consideration.

The face region expansion module 1311 analyzes a 2D video signal (video data), and identifies a region in which the face of a person appears in the video (face region). Further, the face region expansion module 1311 expands the detected face region.

The person feature calculator 1312 calculates the feature quantities of the flesh color and the hair color of the person. First, the person feature calculator 1312 calculates a feature quantity based on an image in the face region before expansion (first feature quantity). The person feature calculator 1312 calculates a feature quantity based on an image in an expanded face region that is expanded (second feature quantity).

The inmost color region determination module 1313 estimates the composition from the 2D video, and determines an inmost color region including a pixel in the inmost color based on the estimated composition and the above expanded face region.

The depth generator 1314 calculates the depth of each of the pixels or each of the regions of the 2D video based on the 2D video and the inmost color determined by the inmost color region determination module 1313.

The depth corrector 1315 calculates a correction value for correcting the depth, and corrects the depth using the calculated correction value.

The memory 1316 stores a template used for detecting a face and a template used for estimating a composition in advance. The memory 1316 provides the template used for detecting the face to the face region expansion module 1311. The memory 1316 provides the template used for estimating the composition to the inmost color region determination module 1313.

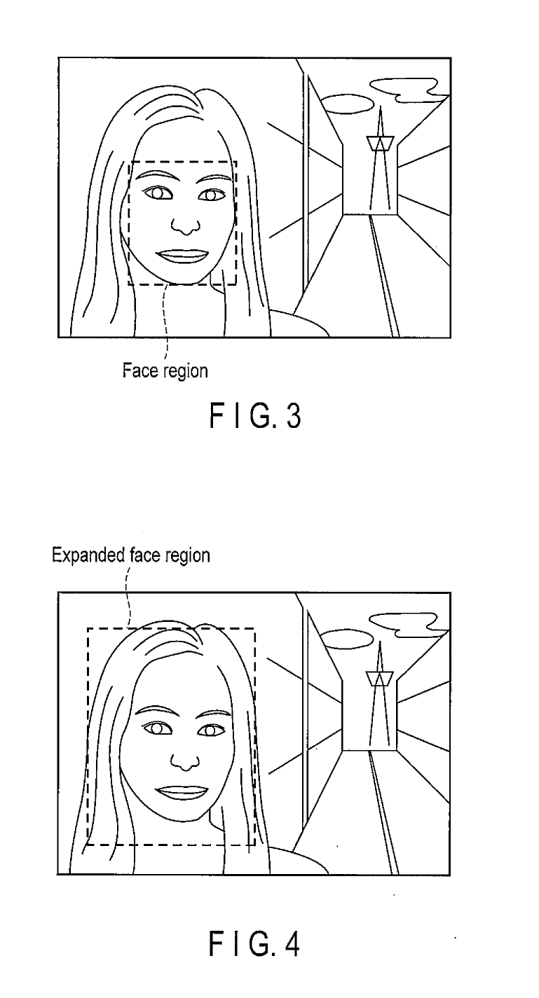

The face region expansion module 1311 analyzes the 2D video signal (video data), and identifies a region in which the face of a person appears in the video (face region). FIG. 3 illustrates an example of a face region detected by the face region expansion module 1311. It should be noted that when multiple faces appear in one video, the face region expansion module 1311 may be configured to identify multiple face regions.

The face region represents coordinate information about the top, bottom, right, and left of the region identified as the region in which a face appears. Further, for example, the face region expansion module 1311 may be configured to calculate the position of the face region and the size of the face region.

It should be noted that the face region expansion module 1311 may be configured to detect the face region according to any method. For example, the face region expansion module 1311 detects the face region by comparing the face region with the template set in advance.

Further, the face region expansion module 1311 expands the detected face region. FIG. 4 illustrates an example of a face region expanded by the face region expansion module 1311 (expanded face region).

The expanded face region is a region including a region in which the face of a person appears and a region in which hair appears (hair region). For example, the face region expansion module 1311 calculates an expansion rate based on the detected face region and a ratio analysis of the face region of each face. The face region expansion module 1311 calculates an expanded face region including the face region and the hair region by expanding the face region using the calculated expansion rate.

When multiple face regions appear in one video, the face region expansion module 1311 may be configured to calculate the expanded face region of each face region.

The person feature calculator 1312 calculates the feature quantities of the flesh color and the hair color of the person. First, the person feature calculator 1312 calculates a feature quantity based on an image in the face region before expansion (first feature quantity).

Further, the person feature calculator 1312 estimates the hair region based on difference between the image in the expanded face region and the image in the face region. Alternatively, the person feature calculator 1312 may be configured to estimate the hair region by excluding a region of pixels in the flesh color (predetermined color) from the image of the expanded face region. The person feature calculator 1312 calculates a feature quantity (second feature quantity) based on the image in the hair region.

When there are multiple face regions and multiple expanded face regions in one video, the person feature calculator 1312 may be configured to calculate the first feature quantity or the second feature quantity, for each face region or for each expanded face region.

The inmost color region determination module 1313 determines a region in the inmost color. The inmost color (color of most far screen) represents a color of a pixel in a region of which depth is the lowest. The inmost color region determination module 1313 estimates the composition from the 2D video, and determines an inmost color region including a pixel in the inmost color based on the estimated composition and the above expanded face region.

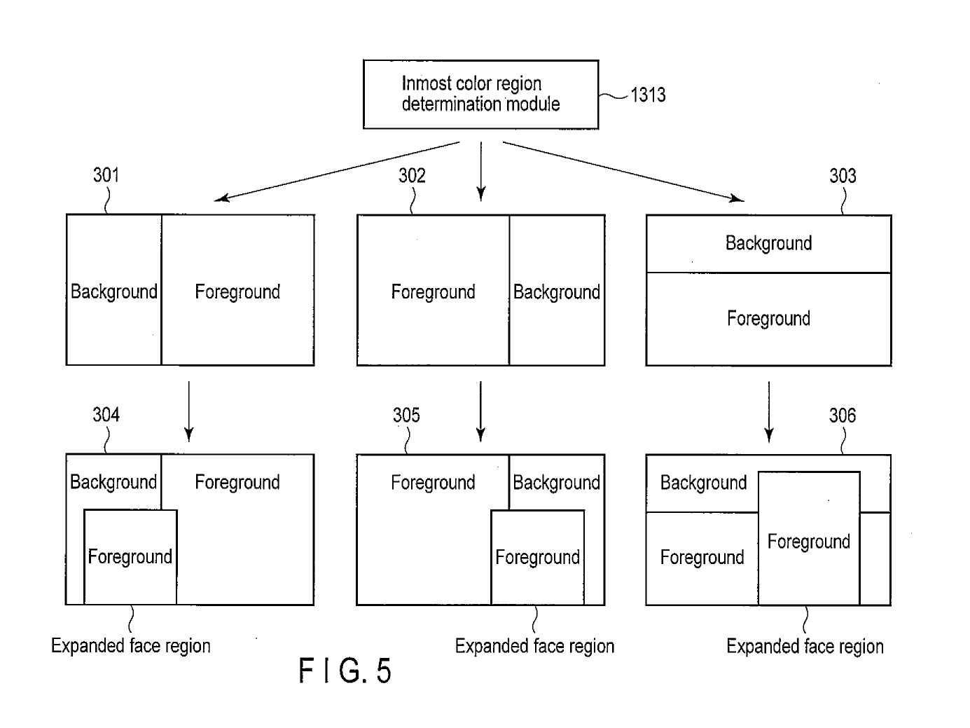

FIG. 5 illustrates an example of processing performed by the inmost color region determination module 1313. The inmost color region determination module 1313 determines the inmost color region appropriate according to the composition. Therefore, the inmost color region determination module 1313 identifies the pattern of the composition of the 2D video based on the 2D video and the template set in advance.

For example, the inmost color region determination module 1313 determines that the composition of the 2D video is any one of a composition pattern 301, a composition pattern 302, and a composition pattern 303 based on the template.

The composition pattern 301 is a composition in which a foreground is located at the right side of the screen and a background is located at the left side of the screen. The composition pattern 302 is a composition in which the foreground is located at the left side of the screen and the background is located at the right side of the screen. The composition pattern 303 is a composition in which the foreground is located at the lower side of the screen and the background is located at the upper side of the screen.

In the above explanation, the inmost color region determination module 1313 is configured to select one of three patterns of compositions. However, the configuration is not limited thereto. The inmost color region determination module 1313 may be configured to further select one of patterns of multiple compositions in which the foreground and the background are divided into more details.

Furthermore, the inmost color region determination module 1313 treats the expanded face region as the foreground in order to avoid further determining that a color of, e.g., the face and the hair of a person, is the inmost color. In this case, the inmost color region determination module 1313 arranges an expanded face region as the foreground in the composition pattern 301, and generates a composition pattern 304. The inmost color region determination module 1313 arranges an expanded face region as the foreground in the composition pattern 302, and generates a composition pattern 305. The inmost color region determination module 1313 arranges an expanded face region as the foreground in the composition pattern 303, and generates a composition pattern 306.

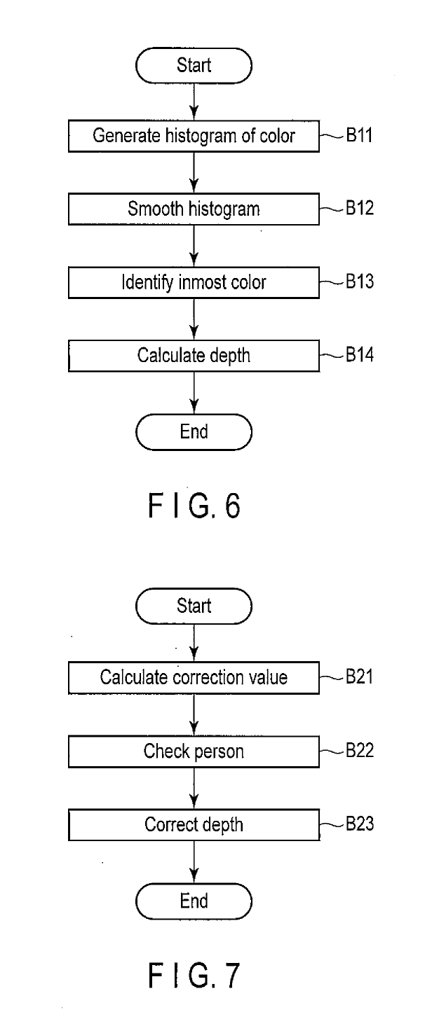

FIG. 6 illustrates an example of processing of the inmost color region determination module 1313 and the depth generator 1314.

The inmost color region determination module 1313 calculates a histogram of color components from the original 2D video in block B11. In this case, the inmost color region determination module 1313 calculates a color histogram by assigning weights according to the composition pattern generated in the above processing. For example, the inmost color region determination module 1313 calculates a histogram in such a manner that the frequency of a pixel in the background portion is +1 and the frequency of a pixel in the foreground portion is −1.

The inmost color region determination module 1313 smoothes the calculated histogram in block B12. Further, the inmost color region determination module 1313 identifies the inmost color in block B13. For example, the inmost color region determination module 1313 identifies a color of the highest frequency in the color histogram as an inmost color.

The depth generator 1314 calculates a depth (first depth) by color 3D processing in block B14. The depth generator 1314 calculates an absolute difference between color information of color of each pixel and color information of the inmost color. The depth generator 1314 calculates the first depth by multiplying the calculated absolute difference by a color correction threshold set in advance based on input (correction coefficient). It should be noted that the depth generator 1314 calculates the first depth in the region of the 2D video except the expanded face region.

The person feature calculator 1312 also calculates the depth (second depth) of the image in the face region by face 3D processing. For example, the person feature calculator 1312 may be configured to calculate the first feature quantity as the second depth. The person feature calculator 1312 may be configured to calculate the second depth based on the first feature quantity and depth data in the shape of a human set in advance. The person feature calculator 1312 may be configured to convert the first feature quantity into the second depth by other processing. Furthermore, the person feature calculator 1312 may be configured to newly calculate the second depth from the image in the face region.

FIG. 7 illustrates an example of processing of the depth corrector 1315.

The depth corrector 1315 calculates the correction value for correcting the depth, and corrects the first depth and the second depth calculated according to the color 3D processing using the calculated correction value.

The depth corrector 1315 calculates the correction value for correcting the depth in block B21. First, the depth corrector 1315 calculates a depth of the expanded face region (third depth) based on the first feature quantity and the second feature quantity calculated by the person feature calculator 1312 from the image in the expanded face region.

It should be noted that the depth corrector 1315 calculates one value as the third depth of the expanded face region. For example, the depth corrector 1315 calculates the third depth by equalizing the first feature quantity and the second feature quantity. The depth corrector 1315 obtains the depth from the absolute difference from the inmost color using the feature quantities of the flesh color and the hair color. In other words, a mean value, an intermediate value, or the like of the feature quantity of face region (first feature quantity) and the feature quantity of the hair region (second feature quantity) are calculated, and the third depth is calculated using the calculated value.

When there are multiple expanded face regions in one video, the depth corrector 1315 calculates the third depth of each of the expanded face regions.

The depth corrector 1315 checks whether a person appears in each of the face regions in the 2D video in block B22. For example, in each of the face regions, the depth corrector 1315 checks whether a person appears in the face region by comparing a pixel in the region and the feature quantities of the flesh color and the hair color.

In block B23, the depth corrector 1315 corrects the depth in the face region which is determined to include a person appearing therein. For example, the depth corrector 1315 employs, as an ultimate depth (fourth depth), a higher one of the second depth calculated in the face 3D processing and the third depth.

Specifically, the depth corrector 1315 compares the second depth and the third depth of each pixel or each region in the face region, and outputs a higher value (depth displayed at a position closer to the user) as the fourth depth.

In other words, the depth corrector 1315 employs the first depth as the fourth depth of the region of the 2D video except the expanded face region. The depth corrector 1315 employs the third depth as the fourth depth of the region of the expanded face region except the face region. Furthermore, the depth corrector 1315 employs a higher one of the second depth and the third depth as the fourth depth of the face region.

As described above, the broadcast receiving apparatus 100 calculates the first depth from the entire 2D video. The broadcast receiving apparatus 100 calculates the second depth from the image in the face region in which the face of the person appears in the 2D video. The broadcast receiving apparatus 100 calculates the first feature quantity from the image in the face region. Further, the broadcast receiving apparatus 100 calculates the second feature quantity from the image in the expanded face region including the hair of the person. The broadcast receiving apparatus 100 calculates the third path using the first feature quantity and the second feature quantity. Furthermore, the broadcast receiving apparatus 100 calculates the fourth depth based on the first depth, the second depth, and the third depth.

As described above, the video processing module 131 of the broadcast receiving apparatus 100 performs 2D-3D conversion for converting a 2D video into a 3D video using the fourth depth. That is, the video processing module 131 generates the left eye image and the right eye image from the 2D video signal based on the calculated fourth depth, and outputs the left eye image and the right eye image as the 3D video signal. Therefore, the broadcast receiving apparatus 100 can generate more natural 3D video from the 2D video. As a result, the image processing apparatus and the controlling method for the image processing apparatus can be provided that can generate more natural 3D video.

Functions described in the above embodiment may be constituted not only with use of hardware but also with use of software, for example, by making a computer read a program which describes the functions. Alternatively, the functions each may be constituted by appropriately selecting either software or hardware.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing apparatus comprising:
a composition estimation module configured to estimate a composition from a two-dimensional image;
an inmost color determination module configured to determine an inmost color based on the estimated composition and the two-dimensional image;
a first depth generator configured to generate a first depth for each of multiple regions in the two-dimensional image based on the inmost color; and
an image processor configured to convert the two-dimensional image into a three-dimensional image using the first depth.

2. The image processing apparatus of claim 1, further comprising:
a face region detector configured to detect from the two-dimensional image a face region where a face of a person appears; and
a face region expansion module configured to calculate an expanded face region comprising the face region and a region where hair of the person appears,
wherein the composition estimation module is further configured to estimate a composition from the two-dimensional image and the expanded face region.

3. The image processing apparatus of claim 2, further comprising a second depth generator configured to calculate a second depth from the two-dimensional image in the face region,
wherein the image processor is further configured to use the first depth and the second depth to convert the two-dimensional image into the three-dimensional image.

4. The image processing apparatus of claim 3, further comprising a third depth generator configured to calculate a third depth based on the two-dimensional image in the face region and the two-dimensional image in the expanded face region,
wherein the image processor is further configured to use the first depth, the second depth, and the third depth to convert the two-dimensional image into the three-dimensional image.

5. The image processing apparatus of claim 4, wherein the image processor is further configured to use one of the second depth and the third depth for converting the two-dimensional image in the expanded face region into the three-dimensional image.

6. The image processing apparatus of claim 5, wherein the image processor is further configured to use a larger of the second depth and the third depth for converting the two-dimensional image in the expanded face region into the three-dimensional image.

7. The image processing apparatus of claim 4, wherein the third depth generator is further configured to equalize a feature of the two-dimensional image in the face region and a feature of the two-dimensional image in the expanded face region.

8. The image processing apparatus of claim 1, further comprising a display configured to display the three-dimensional image converted by the image processor.

9. A controlling method for an image processing apparatus, comprising:
estimating a composition from a two-dimensional image;
determining an inmost color based on the estimated composition and the two-dimensional image;
generating a first depth for each of multiple regions in the two-dimensional image based on the inmost color and the two-dimensional image; and
converting the two-dimensional image into a three-dimensional image using the first depth.
